(19) United States
(12) Patent Application Publication
(10) Pub. No.: US 2017/0334238 A1
(43) Pub. Date: Nov. 23, 2017

(54) DECORATIVE IMPRINTING BODY AND MANUFACTURING APPARATUS THEREFOR

(71) Applicants: Kwang Mi JUNG, Seoul (KR); DAEDO PLATING CO., LTD., Seoul (KR)

(72) Inventor: Kwang Mi JUNG, Seoul (KR)

(73) Assignees: DAEDO PLATING CO., LTD., Seoul (KR); Kwang Mi JUNG, Seoul (KR)

(21) Appl. No.: 15/533,038

(22) PCT Filed: Mar. 25, 2015
(86) PCT No.: PCT/KR2015/002907

§ 371 Date: Jun. 13, 2017

(30) Foreign Application Priority Data
Dec. 30, 2014 (KR) 10-2014-0193714

(51) Int. Cl. B44C 5/04; B22C 9/22; B22C 9/08; B22D 25/02; B22C 9/06

(52) U.S. Cl. CPC B44C 5/0415; B44C 5/0453; B22D 25/02; B22C 9/06; B22C 9/082; B22C 9/22

(57) ABSTRACT

A decorative emblem comprises a plurality of unit emblem bodies; a plurality of fastening legs connected correspondingly to the plurality of unit emblem bodies and having a reduced diameter portion formed on the center thereof in such a manner as to be easily bent and broken; and leg fixing bars adapted to fix the ends of the fastening legs thereto.

### TECHNICAL FIELD

The present invention relates to a decorative emblem and an apparatus for manufacturing the same, and more particularly, to a decorative emblem and an apparatus for manufacturing the same wherein a plurality of unit emblem bodies is successively connected to form a single body, so that plating, coating and polishing are carried out on the single body.

### BACKGROUND ART

Generally, trademarks or logos as decorative emblems are attached to products such as bags, clothes, and so on so as to provide quality assurance, source display, and decorations of the products. For example, metal characters, ‘BEANPOLE’ are used as the decorative emblem.

FIG. 1 is a perspective view showing a conventional decorative emblem 10. As shown in FIG. 1, the conventional decorative emblem 10 has a plurality of unit emblem bodies 20 separated independently from each other and fastening legs 21 formed on each unit emblem body 20. For example, if the decorative emblem 10 is formed of metal characters, ‘BEANPOLE’, eight unit emblem bodies 20 are needed, and the fastening legs 21 are also needed for each character.

However, the conventional decorative emblem 10 has the following problems.

Since the sizes of the unit emblem bodies 20 are small, first, it is very hard to conduct plating, coating or polishing for the individual unit emblem body 20.

Upon the plating of the unit emblem bodies 20, for example, if the unit emblem bodies 20 are brought into contact with a given place of a plating bath, the plating is not carried out well on the contacted portions of the unit emblem bodies 20 with the plating bath, and accordingly, the unit emblem bodies 20 have to hang in the air in such a manner as to be not contacted with anything. Since the sizes of the unit emblem bodies 20 are small and the number of unit emblem bodies 20 is large, at this time, a long period of time for plating is extended and a high degree of concentration upon the plating is also needed (Even in case of coating or polishing, of course, such problems happen).

Upon the plating of the unit emblem bodies 20, further, hooks for hanging the unit emblem bodies 20 on the plating bath are not provided on the unit emblem bodies 20, so that it is difficult to hang the unit emblem bodies 20 on the plating bath.

In addition, plating results are differently obtained according to the positions of the unit emblem bodies 20 on the plating bath, so that unfortunately, the respective unit emblem bodies 20 of the decorative emblem 10 are not plated uniformly.

### DISCLOSURE

### Technical Problem

Accordingly, the present invention has been made in view of the above-mentioned problems occurring in the prior art, and it is an object of the present invention to provide a decorative emblem and an apparatus for manufacturing the same wherein a plurality of unit emblem bodies is successively connected to form a single body.

### Technical Solution

To accomplish the above-mentioned object, according to a first aspect of the present invention, there is provided a decorative emblem including: a plurality of unit emblem bodies; plurality of fastening legs connected correspondingly to the plurality of unit emblem bodies and having a reduced diameter portion formed on the center thereof in such a manner as to be reduced in thickness and thus easily bent and broken; and leg fixing bars adapted to fix the ends of the fastening legs thereto.

According to the present invention, desirably, the decorative emblem further includes spine bars disposed between the plurality of unit emblem bodies and the plurality of fastening legs and a plurality of connection legs adapted to connect the respective unit emblem bodies and the spine bars with each other, the plurality of fastening legs being connected to the spine bars. At this time, the plurality of fastening legs is connected to the spine bars in such a manner as to allow the plurality of connection legs to be located at the portions connected to the spine bars.

To accomplish the above-mentioned object, according to a second aspect of the present invention, there is provided an apparatus for manufacturing a decorative emblem, the apparatus including: an upper plate having a molten metal pouring hole formed thereon to pass through the top and underside thereof and a plurality of unit emblem body grooves formed on the underside thereof; and a lower plate having a navel part convexedly protruding from the top surface thereof in such a manner as to be inserted into the molten metal pouring hole, while having a given gap with the molten metal pouring hole, leg fixing bar grooves formed on the top thereof in such a manner as to be extended laterally from the navel part, two sliding plates disposed on the portion where each leg fixing bar groove is formed in such a manner as to allow the side surfaces thereof to slidingly face each other, a plurality of fastening leg grooves formed on the facing portions of the side surfaces of the two sliding plates to connect the leg fixing bar grooves and the plurality of unit emblem body grooves with each other, wherein a molten metal poured into the molten metal pouring hole is introduced into the leg fixing bar grooves through the gap between the navel part and the molten metal pouring hole and is then filled into the plurality of unit emblem body grooves through the plurality of fastening leg grooves.

According to the present invention, desirably, the upper plate further includes spine bar grooves formed beside the plurality of unit emblem body grooves formed on the underside thereof and a plurality of connection leg grooves adapted to connect the spine bar grooves and the plurality of unit emblem body grooves with each other, and the leg fixing bar grooves disposed parallel to the spine bar grooves, while the plurality of fastening leg grooves being formed to connect the leg fixing bar grooves and the spin bar grooves with each other, so that the molten metal poured into the molten metal pouring hole is introduced into the leg fixing bar grooves through the gap between the navel part and the molten metal pouring hole and is then filled into the plurality of unit emblem body grooves through the plurality of fastening leg grooves, the spine bar grooves and the plurality of connection leg grooves, sequentially.

According to the present invention, desirably, each leg fixing bar groove has gas discharging grooves formed thereon to discharge gas therefrom.

According to the present invention, desirably, each spine bar groove has a gas discharging groove formed thereon to discharge gas therefrom.

According to the present invention, desirably, each fastening leg groove has a protruding portion formed on the center thereof to reduce the diameter of each fastening leg.

According to the present invention, desirably, the sliding plates are located on a recessed portion formed downwardly from the top surface of the lower plate, so that a stepped portion is formed between the portion where the navel part is located and the portion where the sliding plates are located, and the lower plate has pin holes formed around the navel part into which the molten metal flows through the molten metal pouring hole so as to push a product obtained through the solidness of the molten metal by means of discharging pins inserted thereinto. At this time, each leg fixing bar groove formed under the sliding plates has a protruding portion formed on the starting position thereof to reduce the diameter of each leg fixing bar.

According to the present invention, desirably, the navel part becomes reduced in thickness toward the upper portion thereof.

According to the present invention, desirably, the plurality of fastening leg grooves is located correspondingly to the positions at which the plurality of connection leg grooves is located.

### Advantageous Effects

According to the present invention, the decorative emblem has the plurality of unit emblem bodies successively connected with each other to form a single body, so that there is no need to laboriously plate the plurality of unit emblem bodies one by one, and also has hooks or spare portions formed thereon to hang the decorative emblem while being plated, so that the plating is easily carried out. Further, the plating for the plurality of unit emblem bodies as one set, without any separation, is carried out, so that the decorative emblem has good plating uniformity. These advantages are also taken upon coating or polishing, in addition to the plating.

### DESCRIPTION OF DRAWINGS

FIG. 1 is a perspective view showing a conventional decorative emblem 10.

FIG. 2 is a perspective view showing a decorative emblem 110 according to the present invention.

FIGS. 3 to 5 are perspective and sectional views showing an apparatus 200 for manufacturing a decorative emblem according to the present invention.

FIGS. 6 to 8 are perspective and sectional views showing the processes for manufacturing the decorative emblem 110 using the apparatus 200 according to the present invention.

FIG. 9 is a perspective view showing the advantages in plating for the decorative emblem 110 according to the present invention.

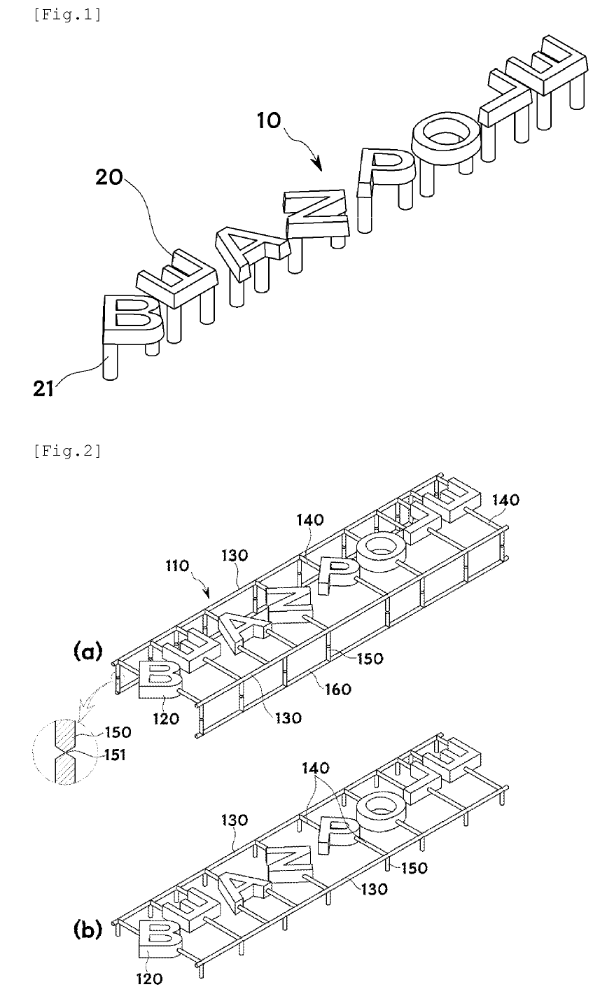

[Explanation on reference numerals in the drawings]

| | |
|---|---|
| 110: decorative emblem | 120: unit emblem body |
| 130: spine bar | 140: connection leg |
| 150: fastening leg | 151: reduced diameter portion |

160: leg fixing bar
200: apparatus for manufacturing a decorative emblem

| | |
|---|---|
| 201: upper plate | 202: lower plate |
| 211: guide hole | 212: connection hole |

220: unit emblem body groove
230: spine bar groove

| | |
|---|---|
| 235, 265: gas discharging groove | 240: connection leg groove |

250: fastening leg groove
251, 261: protruding portion
260: leg fixing bar groove
270: molten metal pouring hole

| | |
|---|---|
| 280: navel part | 282: sliding plate |
| 290: pin hole | 295: discharging pin |

### BEST MODE FOR INVENTION

Hereinafter, an explanation on a decorative emblem and an apparatus for manufacturing the same according to the present invention will be in detail described with reference to the attached drawing. Before the present invention is disclosed and described, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one of ordinary skill in the art to variously employ the present invention in virtually any appropriately detailed structure.

FIG. 2 is a perspective view showing a decorative emblem 110 according to the present invention. As shown in FIG. 2a, the decorative emblem 110 according to the present invention includes unit emblem bodies 120, spine bars 130, connection legs 140, fastening legs 150, and leg fixing bars 160.

The unit emblem bodies 120 are disposed beside the spine bars 130 in such a manner as to be connected to the spine bars 130 through the connection legs 140, and the fastening legs 150 are connected to the spine bars 130 in such a manner as to be vertical to the connection legs 140. Each fastening leg 150 has a reduced diameter portion 151 formed thereon in such a manner as to be easily bent and broken at the center thereof. The leg fixing bars 160 are adapted to fix the fastening legs 150 thereto in such a manner as to prevent the fastening legs 150 from being twisted from their original positions. The leg fixing bars 160 are disposed parallel to the spine bars 130, while fixing the ends of the fastening legs 150 thereto.

The fastening legs 150 are desirably connected to the spine bars 130 in such a manner as to allow the connection legs 140 to be located at the portions connected to the spine bars 130. This improves the reliability in a manufacturing process, which will be discussed later.

If it is desired to install the decorative emblem 110 according to the present invention on an object to be decorated like bags, clothes, and so on, the fastening legs 150 are broken with respect to the reduced diameter portions 151 in such a manner as to be inserted into the object to be decorated, and accordingly, the decorative emblem 110 as shown in FIG. 2b is made.

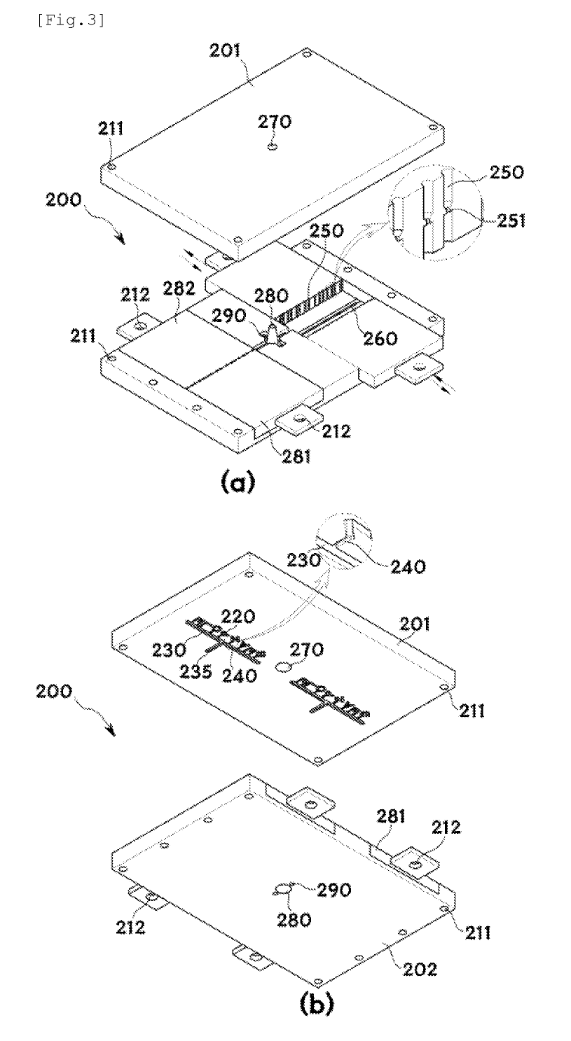

FIGS. 3 to 5 are perspective and sectional views showing an apparatus 200 for manufacturing a decorative emblem according to the present invention.

As shown in FIGS. 3a and 3b, the apparatus 200 for manufacturing a decorative emblem according to the present invention includes an upper plate 201 and a lower plate 202.

The upper plate 201 has a molten metal pouring hole 270 formed to pass through the top and underside thereof and a plurality of unit emblem body grooves 220 formed on the underside thereof to form the unit emblem bodies 120. Further, the upper plate 201 has spine bar grooves 230 formed beside the unit emblem body grooves 220 on the underside thereof to form the spine bars 130, and the unit emblem body grooves 220 are connected to the spine bar grooves 230 by means of connection leg grooves 240 formed to form the connection legs 140. Each spine bar groove 230 has a gas discharging groove 235 formed to discharge gas therefrom.

The lower plate 202 has a navel part 280 convexedly protruding from the top surface thereof in such a manner as to be inserted into the molten metal pouring hole 270, while having a given gap with the molten metal pouring hole 270, and leg fixing bar grooves 260 formed laterally from the navel part 280 to form the leg fixing bars 160.

Two sliding plates 281 and 282 are disposed on the portion where each leg fixing bar groove 260 is formed in such a manner as to allow the side surfaces thereof to slidingly face each other, and at this time, the facing portions of the side surfaces of the two sliding plates 281 and 282 are located on each leg fixing bar groove 260. Further, the lower plate 202 has a plurality of fastening leg grooves 250 formed on the facing portions of the side surfaces of the two sliding plates 281 and 282. Desirably, the fastening leg grooves 250 are located correspondingly to the positions at which the connection leg grooves 240 are located.

Further, the upper plate 201 and the lower plate 202 have guide holes 211 formed on the corners thereof in such a manner as to pass guide bars (not shown) therethrough, thereby preventing them from being misaligned. The sliding plates 281 and 282 have connection holes 212 formed thereon in such a manner as to be connected to external devices to push and pull them.

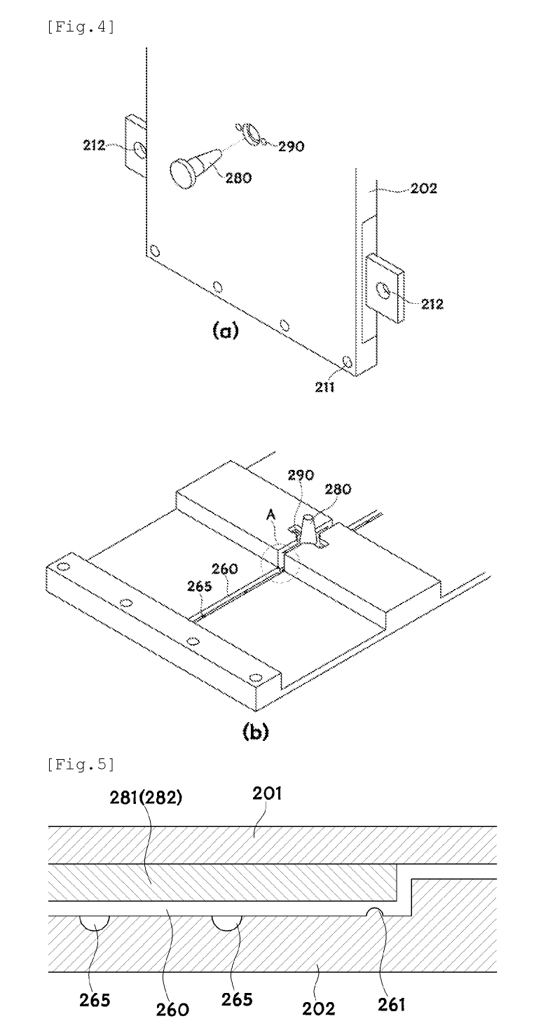

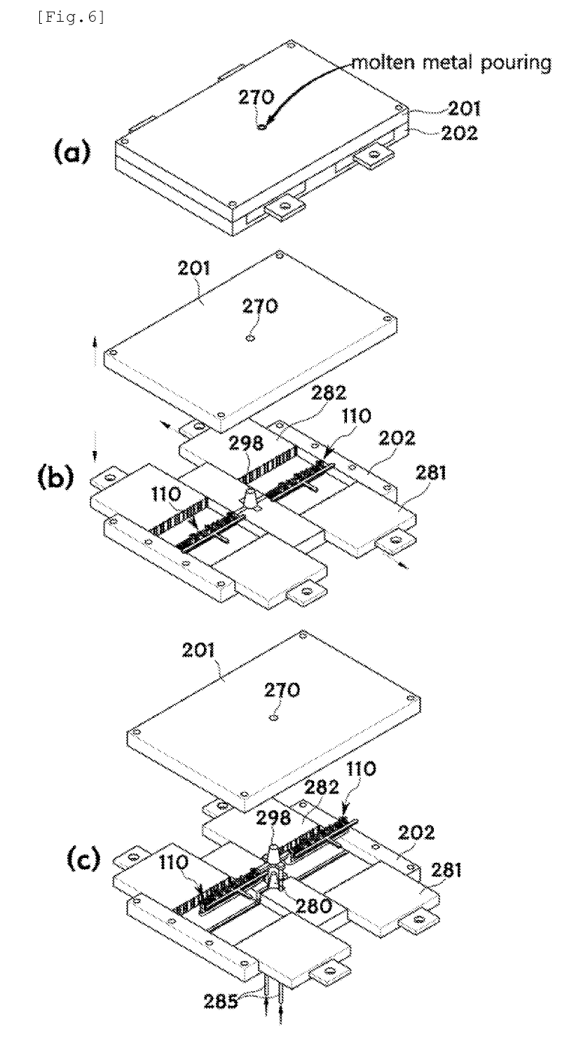

The navel part 280 is adapted to easily separate a product obtained through the solidness of the molten metal from the lower plate 202, and as shown in FIGS. 4a and 4b, the navel part 280 is assembled to pass through the lower plate 202 from the underside of the lower plate 202 toward the top of the lower plate 202 in such a manner as to protrude from the top of the lower plate 202. Particularly, the navel part 280 becomes reduced in thickness toward the upper portion thereof. Pin holes 290 are formed around the navel part 280 to push the product obtained through the solidness of the molten metal by means of discharging pins 285 (See FIG. 6c) inserted thereinto.

The lower plate 202 has a recessed portion formed from the top surface thereof in such a manner as to locate the sliding plates 281 and 282 thereon, and accordingly, a stepped portion is formed between the portion where the navel part 280 is located and the portion where the sliding plates 282 and 282 are located to allow the top surfaces of the sliding plates 282 and 282 to become flat with respect to the installation portion of the navel part 280, thereby desirably having no gap with the upper plate 201.

The pin holes 290 are desirably formed on the portion where the sliding plates 282 and 282 are not formed, that is, on the stepped portion. In this case, the portion of the lower plate 202 under the sliding plates 282 and 282 is a portion where the leg fixing bar grooves 260 are formed to form the leg fixing bars 160, but because it is small in thickness, it may push by means of the discharging pins 285 and be thus easily damaged and broken. Desirably, each leg fixing bar groove 260 has gas discharging grooves 265 formed thereon to discharge gas therefrom.

As shown in FIG. 5 to explain a portion ‘A’ of FIG. 4b, a protruding portion 261 is desirably formed on a portion at which each leg fixing bar groove 260 formed under the sliding plates 281 and 282 starts so as to reduce the diameter of each leg fixing bar. As a result, the leg fixing bar 160 can be easily broken around the protruding portion 261. In the same manner as above, as shown in FIG. 3a, the fastening leg grooves 250 have protruding portions 251 formed thereon.

FIGS. 6a to 6c are perspective views showing the processes for manufacturing the decorative emblem 110 using the apparatus 200 according to the present invention. As shown in FIG. 6a, first, the upper plate 201 and the lower plate 202 come into close contact with each other, and next, a molten metal is poured into the molten metal pouring hole 270. After that, the molten metal is introduced into the leg fixing bar grooves 260 through the gap between the navel part 280 and the molten metal pouring hole 270 and is then filled into the unit emblem body grooves 220 through the fastening leg grooves 250, the spine bar grooves 230 and the connection leg grooves 240, sequentially.

Since there is no gap between the upper plate 201 and the lower plate 202, at this time, gas discharging means, which is adapted to push gas from the above-mentioned introduction passage of the molten metal, is needed to allow the molten metal to flow into the unit emblem body grooves 220, and according to the present invention, the gas discharging grooves 235 and 265 are formed on the leg fixing bar grooves 260 and the spine bar grooves 230, so that the gas existing on the passage pushes toward the gas discharging grooves 235 and 265 to allow the molten metal to naturally move along the passage. If the gas discharging grooves 235 and 265 do not exist, the molten metal is not uniformly moved, so that the characters indicating the decorative emblem are not formed well.

As a pressure of the molten metal is greatest on a portion just before the molten metal is fluid mechanically distributed, it is advantageous to conduct gas discharging on the portion just before the molten metal is distributed. Accordingly, the gas discharging grooves 235 and 265 are desirably formed on the leg fixing bar grooves 260 and the spine bar grooves 230.

The fastening leg grooves 250 and the connection leg grooves 240 are located correspondingly to each other, so that the molten metal passes through the fastening leg grooves 250 and the connection leg grooves 240 at the same time and is almost at the same time filled into the unit emblem body grooves 220. This means that the molten metal pouring and cooling are at the same time carried out for the respective unit emblem body grooves 220, without having a big time difference therebetween, thereby being very advantageous in controlling the processing conditions.

If the molten metal becomes solid through the cooling after the pouring, as shown in FIG. 6b, the upper plate 201 and the lower plate 202 are separated from each other, and also, the sliding plates 281 and 282 are isolated from each other. The separation order is not necessarily determined, but may be changed according to situations.

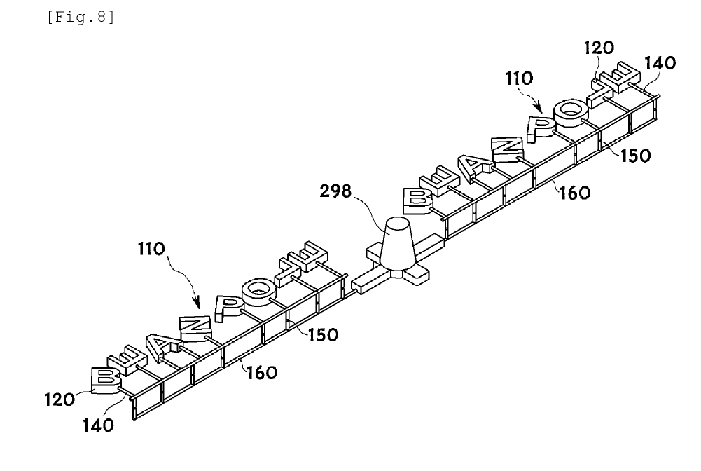

Next, as shown in FIG. 6c, the product is pushed through the discharging pins 285 and is then separated from the upper plate 201 and the lower plate 202. Accordingly, as shown in FIG. 8, the decorative emblem 110 is obtained in the state where the unit emblem bodies 120 are connected with each other by means of a conical part 298. The conical part 298 is formed around the navel part 280, and if the leg fixing bar 160 is broken on the reduced diameter portion thereof formed by means of the protruding portion 261 as shown in FIG. 5, the conical part 298 is separated from the decorative emblem 110. After the separation, the conical part 298 is recycled. According to the present invention, a portion lifted through the discharging pins 295 is the conical part 298, and as the navel part 280 becomes reduced in thickness toward the upper portion thereof, the conical part 298 can be easily separated from the navel part 280.

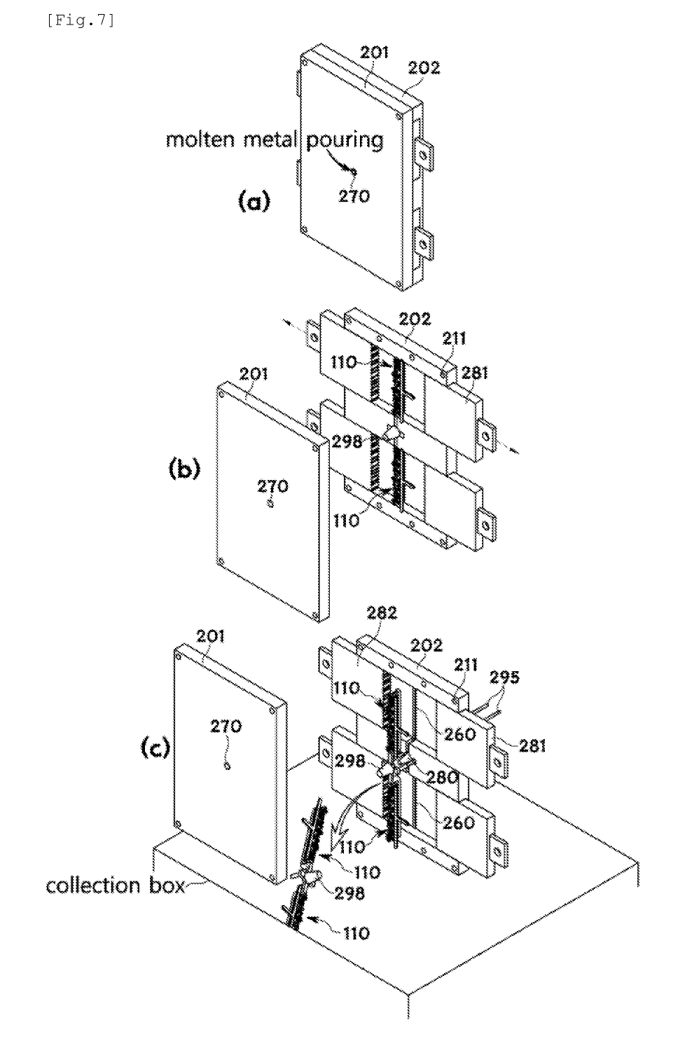

According to the present invention, the upper plate 201 and the lower plate 202 are not always located up and down, but for example, they are just located up and down to obtain the consistency of the terms. As shown in FIGS. 7a to 7c, accordingly, the upper plate 201 and the lower plate 202 may be erected to face each other. In this case, as shown in FIG. 7c, the product is separated from the upper plate 201 and the lower plate 202 and falls down, and accordingly, a product collection box is located under the upper plate 201 and the lower plate 202 to improve the conveniences in collecting products.

As shown in FIGS. 2a and 2b, the decorative emblem 110 according to the present invention has the spine bars 130 located on both sides thereof, and as shown in FIG. 8, it may have the spine bar 130 located on one side thereof, which is of course carried out according to the change on the design of the mold.

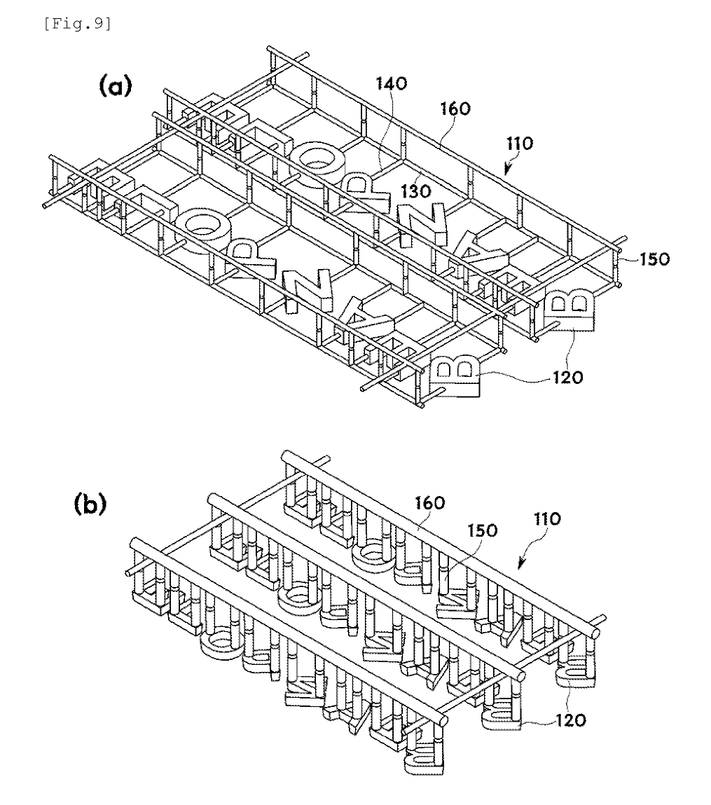

FIGS. 9a and 9b are perspective views showing the advantages in plating for the decorative emblem 110 according to the present invention. As shown in FIG. 9a, the decorative emblem 110 turns over to hang the leg fixing bar 160, and in this state, if plating for the decorative emblem 110 is carried out, the leg fixing bar 160 hanging on a given place is not plated well. However, the entire decorative emblem 110 except the leg fixing bar 160 can be plated well.

The leg fixing bar 160 is the portion that is cut off from the fastening legs 150 through the reduced diameter portions 151 formed on the fastening legs 150 and is not used actually, so that the actually used portion of the decorative emblem 110 can be uniformly plated.

FIG. 9b shows the case wherein the fastening legs 150 are just connected to the unit emblem bodies 120, without having any spine bars 130 and connection legs 140, and of course, such configuration of the decorative emblem is within the scope of the present invention. In this case, of course, the apparatus 200 for manufacturing the decorative emblem 110 according to the present invention does not need to form any spine bar grooves 230 and connection leg grooves 240.

### INDUSTRIAL APPLICABILITY

According to the present invention, the decorative emblem 110 has the plurality of unit emblem bodies 120 successively connected with each other to form a single body, so that there is no need to laboriously plate the plurality of unit emblem bodies 120 one by one, and also has hooks or spare portions formed thereon to hang the decorative emblem 110 while being plated, so that the plating is easily carried out. Further, the plating for the plurality of unit emblem bodies 120 as one set, without any separation, is carried out, so that the decorative emblem 110 has good plating uniformity. These advantages are also taken upon coating or polishing, in addition to the plating.

1. A decorative emblem comprising:
a plurality of unit emblem bodies;
a plurality of fastening legs connected correspondingly to the plurality of unit emblem bodies and having a reduced diameter portion formed on the center thereof in such a manner as to be easily bent and broken; and
leg fixing bars adapted to fix the ends of the fastening legs thereto.

2. The decorative emblem according to claim 1, further comprising spine bars disposed between the plurality of unit emblem bodies and the plurality of fastening legs and a plurality of connection legs adapted to connect the respective unit emblem bodies and the spine bars with each other, the plurality of fastening legs being connected to the spine bars.

3. The decorative emblem according to claim 2, wherein the plurality of fastening legs is connected to the spine bars in such a manner as to allow the plurality of connection legs to be located at the portions connected to the spine bars.

4. An apparatus for manufacturing a decorative emblem, the apparatus comprising:
an upper plate having a molten metal pouring hole formed to pass through the top and underside thereof and a plurality of unit emblem body grooves formed on the underside thereof; and
a lower plate having a navel part convexedly protruding from the top surface thereof in such a manner as to be inserted into the molten metal pouring hole, while having a given gap with the molten metal pouring hole, leg fixing bar grooves formed on the top thereof in such a manner as to be extended laterally from the navel part, two sliding plates disposed on the portion where each leg fixing bar groove is formed in such a manner as to allow the side surfaces thereof to slidingly face each other, a plurality of fastening leg grooves formed on the facing portions of the side surfaces of the two sliding plates to connect the leg fixing bar grooves and the plurality of unit emblem body grooves with each other,
wherein a molten metal poured into the molten metal pouring hole is introduced into the leg fixing bar grooves through the gap between the navel part and the molten metal pouring hole and is then filled into the plurality of unit emblem body grooves through the plurality of fastening leg grooves.

5. The apparatus according to claim 4, wherein the upper plate further comprises spine bar grooves formed beside the plurality of unit emblem body grooves formed on the underside thereof and a plurality of connection leg grooves adapted to connect the spine bar grooves and the plurality of unit emblem body grooves with each other, and the leg fixing bar grooves disposed parallel to the spine bar grooves, while the plurality of fastening leg grooves being formed to connect the leg fixing bar grooves and the spin bar grooves with each other, so that the molten metal poured into the molten metal pouring hole is introduced into the leg fixing bar grooves through the gap between the navel part and the molten metal pouring hole and is then filled into the plurality of unit emblem body grooves through the plurality of fastening leg grooves, the spine bar grooves and the plurality of connection leg grooves, sequentially.

6. The apparatus according to claim 4, wherein each leg fixing bar groove has gas discharging grooves formed thereon to discharge gas therefrom.

7. The apparatus according to claim 5, wherein each spine bar groove has a gas discharging groove formed thereon to discharge gas therefrom.

8. The apparatus according to claim 4, wherein each fastening leg groove has a protruding portion formed on the center thereof to reduce the diameter of each fastening leg.

9. The apparatus according to claim 4, wherein the sliding plates are located on a recessed portion formed downwardly from the top surface of the lower plate, so that a stepped portion is formed between the portion where the navel part is located and the portion where the sliding plates are located, and the lower plate has pin holes formed around the navel part into which the molten metal flows through the molten metal pouring hole so as to push a product obtained through the solidness of the molten metal by means of discharging pins inserted thereinto.

10. The apparatus according to claim 9, wherein each leg fixing bar groove formed under the sliding plates has a protruding portion formed on the starting position thereof to reduce the diameter of each leg fixing bar.

11. The apparatus according to claim 4, wherein the navel part becomes reduced in thickness toward the upper portion thereof.

12. The apparatus according to claim 5, wherein the plurality of fastening leg grooves is located correspondingly to the positions at which the plurality of connection leg grooves is located.
